(19) United States
(12) Patent Application Publication
(10) Pub. No.: US 2023/0417554 A1
(43) Pub. Date: Dec. 28, 2023

(54) GUIDE DISPLAY CONTROL APPARATUS, GUIDE DISPLAY CONTROL METHOD, AND ROUTE GUIDING SYSTEM

(71) Applicant: Mitsubishi Electric Corporation, Tokyo (JP)

(72) Inventors: Saki MATSUI, Tokyo (JP); Reiko SAKATA, Tokyo (JP); Tatsunari KATAOKA, Tokyo (JP); Naoki FURUHATA, Tokyo (JP); Atsushi SHIMADA, Tokyo (JP)

(73) Assignee: Mitsubishi Electric Corporation, Tokyo (JP)

(21) Appl. No.: 18/244,327

(22) Filed: Sep. 11, 2023

Related U.S. Application Data
(63) Continuation of application No. PCT/JP2021/012901, filed on Mar. 26, 2021.

(51) Int. Cl. G01C 21/20

(52) U.S. Cl. CPC G01C 21/206

(57) ABSTRACT

A guide display control apparatus includes: a detection signal obtaining unit to obtain a detection signal including identification information of a facility user who has entered a monitoring area from an approach detector that detects entry of the facility user into the monitoring area; a destination obtaining unit to obtain a plurality of destinations associated with the identification information included in the detection signal; a travel time predicting unit to search for routes from the monitoring area to the respective destinations, and predict a travel time of the facility user from the monitoring area to each of the destinations on the basis of a search result of the routes; and a display data generating unit to generate display data to display a guide diagram including arrows each indicating a corresponding one of the routes to the respective destinations and the travel time to each of the destinations.

### CROSS-REFERENCE TO RELATED APPLICATION

The present application is a bypass-continuation of International Patent Application No. PCT/JP2021/012901, filed Mar. 26, 2021, the entire contents of which are incorporated herein by reference.

### TECHNICAL FIELD

The present disclosure relates to a guide display control apparatus, a guide display control method, and a route guiding system.

### BACKGROUND ART

As a technology for guiding a facility user who holds a mobile terminal until the facility user reaches a destination in the facility, there is a guide apparatus disclosed in Patent Literature 1. As guidance about a route to a destination, the guide apparatus projects an arrow indicating a direction in which the facility user should proceed on a floor surface of the facility at a branch point in the middle of the route to the destination.

### CITATION LIST

### Patent Literatures

Patent Literature 1: JP 2007-147300 A

### SUMMARY OF INVENTION

### Technical Problem

In the guide apparatus disclosed in Patent Literature 1, when there is a plurality of destinations to be visited by one facility user in a certain facility (hereinafter, such destinations are simply referred to as “a plurality of destinations”), guidance about routes to the respective destinations are not projected on the floor surface of the facility. Therefore, the guide apparatus has a problem. The problem is that when there is a plurality of destinations as described above, one facility user who should visit the destinations cannot achieve an efficient visit such as visiting each of the destinations in order of decreasing distance from the current position.

The present disclosure has been made to solve the above problem, and an object thereof is to obtain a guide display control apparatus and a guide display control method capable of showing routes to respective destinations.

### Solution to Problem

A guide display control apparatus according to the present disclosure includes: detection signal obtaining circuitry to obtain a detection signal including identification information of a facility user who has entered a monitoring area from an approach detector that detects entry of the facility user into the monitoring area; destination obtaining circuitry to obtain a plurality of destinations associated with the identification information included in the detection signal obtained by the detection signal obtaining circuitry; travel time predicting circuitry to search for routes from the monitoring area to the respective destinations obtained by the destination obtaining circuitry, and predict a travel time of the facility user from the monitoring area to each of the destinations on the basis of a search result of the routes; and display data generating circuitry to generate display data to display a guide diagram including arrows each indicating a corresponding one of the routes to the respective destinations searched for by the travel time predicting circuitry and the travel time to each of the destinations predicted by the travel time predicting circuitry. The travel time predicting circuitry calculates, when each of the destinations obtained by the destination obtaining circuitry is a destination with a limited use time, a remaining time until a time limit for use of a corresponding one of the destinations instead of predicting the travel time. The display data generating circuitry generates display data to display a guide diagram including the arrows each indicating the corresponding one of the routes to the respective destinations searched for by the travel time predicting circuitry and the remaining time for each of the destinations calculated by the travel time predicting circuitry.

### Advantageous Effects of Invention

According to the present disclosure, it is possible to show routes to respective destinations.

### BRIEF DESCRIPTION OF DRAWINGS

FIG. 1 is a configuration diagram illustrating a route guiding system according to a first embodiment.

FIG. 2 is a configuration diagram illustrating a guide display control apparatus 2 according to the first embodiment.

FIG. 3 is a hardware configuration diagram illustrating hardware of the guide display control apparatus 2 according to the first embodiment.

FIG. 4 is a hardware configuration diagram of a computer in a case where the guide display control apparatus 2 is implemented by software, firmware, or the like.

FIG. 5 is a flowchart illustrating a guide display control method that is a processing procedure performed in the guide display control apparatus 2.

FIG. 6A is an explanatory diagram illustrating an example of an arrow icon indicating a route to a destination, FIG. 6B is an explanatory diagram illustrating a character string icon indicating a character string “travel time to”, FIG. 6C is an explanatory diagram illustrating a character string icon indicating a character string “remaining time until becomes available”, FIG. 6D is an explanatory diagram illustrating a character string icon indicating a character string “Internal medicine department”, FIG. 6E is an explanatory diagram illustrating a character string icon indicating a character string “dermatology department”, FIG. 6F is an explanatory diagram illustrating a character icon indicating characters “minutes”, and FIG. 6G is an explanatory diagram illustrating number icons indicating numbers “0”, “1”, “2”, “3”, “4”, “5”, “6”, “7”, “8”, and “9”.

FIG. 7 is an explanatory diagram illustrating an example of a guide diagram in a monitoring area.

FIG. 8 is an explanatory diagram illustrating an example of the guide diagram in the monitoring area.

FIG. 9 is a configuration diagram illustrating a route guiding system according to a second embodiment.

FIG. 10 is a configuration diagram illustrating a guide display control apparatus 2 according to the second embodiment.

FIG. 11 is a hardware configuration diagram illustrating hardware of the guide display control apparatus 2 according to the second embodiment.

FIG. 12 is an explanatory diagram illustrating an example of a guide diagram in a monitoring area.

FIG. 13 is a configuration diagram illustrating a guide display control apparatus 2 according to a fourth embodiment.

FIG. 14 is a hardware configuration diagram illustrating hardware of the guide display control apparatus 2 according to the fourth embodiment.

FIG. 15 is an explanatory diagram illustrating an example of a guide diagram in a monitoring area.

FIG. 16 is a configuration diagram illustrating s guide display control apparatus 2 according to a fifth embodiment.

FIG. 17 is a hardware configuration diagram illustrating hardware of the guide display control apparatus 2 according to the fifth embodiment.

### DESCRIPTION OF EMBODIMENTS

Hereinafter, in order to describe the present disclosure in more detail, modes for carrying out the present disclosure will be described with reference to the accompanying drawings.

### First Embodiment

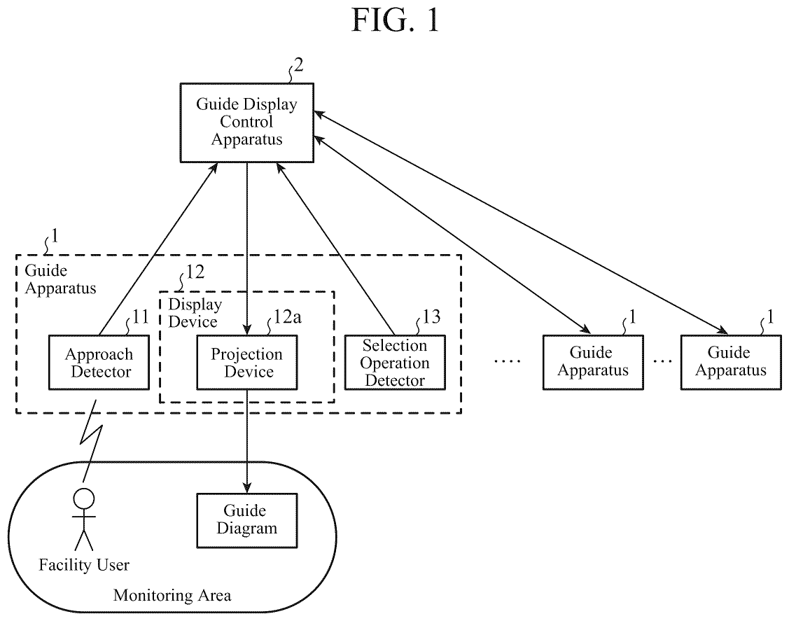

FIG. 1 is a configuration diagram illustrating a route guiding system according to a first embodiment.

The route guiding system illustrated in FIG. 1 includes a guide apparatus 1 and a guide display control apparatus 2.

The guide apparatus 1 includes an approach detector 11, a display device 12, and a selection operation detector 13.

The guide apparatus 1 performs entry detection processing of detecting entry of a facility user into a monitoring area. The monitoring area is an area where the guide apparatus 1 monitors the entrance of the facility user, and is, for example, an area including a branch point in the facility. Specifically, it is an area including an intersection where passages in the facility intersect. The facility here is not limited to a facility in one building, and includes a composite facility in which a plurality of buildings is present in the same site.

The guide apparatus 1 receives a radio wave or the like including identification information of the facility user from a possessed object of the facility user who has entered the monitoring area, and outputs a detection signal including the identification information to the guide display control apparatus 2.

The guide apparatus 1 displays a guide diagram in accordance with display data output from the guide display control apparatus 2.

The possessed object of the facility user includes a radio frequency identification (RFID) tag, a mobile terminal, and the like.

The approach detector 11 is implemented by, for example, a receiver and a transmitter.

When the possessed object of the facility user is, for example, an RFID tag, the approach detector 11 receives a radio wave transmitted from the RFID tag when the facility user enters the monitoring area and it becomes possible to receive the radio wave. The radio wave includes the identification information of the facility user.

When the possessed object of the facility user is, for example, a mobile terminal, the approach detector 11 receives a radio wave of a near field communication system transmitted from the mobile terminal when the facility user enters the monitoring area and it becomes possible to receive the radio wave. The radio wave includes the identification information of the facility user.

When the approach detector 11 can receive the radio wave transmitted from the possessed object of the facility user, the approach detector 11 determines that the facility user has entered the monitoring area, and outputs a detection signal including the identification information of the facility user to the guide display control apparatus 2.

Since a plurality of guide apparatuses 1 is installed in the facility, the detection signal output from the approach detector 11 includes a device number indicating the guide apparatus 1 to which the approach detector 11 belongs in addition to the identification information of the facility user.

In the route guiding system illustrated in FIG. 1, the approach detector 11 receives a radio wave including the identification information of the facility user from the possessed object of the facility user, and outputs a detection signal including the identification information included in the radio wave to the guide display control apparatus 2. However, this is merely an example, and the approach detector 11 includes a camera that captures an image of the face of the facility user, and specifies the facility user by performing face authentication processing of the facility user on the basis of the image captured by the camera. Then, the approach detector 11 may output a detection signal including the identification information of the specified facility user to the guide display control apparatus 2.

The display device 12 displays the guide diagram in accordance with the display data output from the guide display control apparatus 2.

That is, the display device 12 includes a projection device 12a, and the projection device 12a projects the guide diagram on a floor surface or the like of the monitoring area in accordance with the display data output from the guide display control apparatus 2.

The selection operation detector 13 is implemented by an infrared detector, a camera, or the like.

After the guide diagram is displayed by the display device 12, the selection operation detector 13 detects a selection operation by the facility user to select a route to one of a plurality of destinations from among routes to the plurality of destinations. For example, when the facility user steps on an arrow indicating a certain route included in the guide diagram, the selection operation detector 13 determines that the facility user has performed an operation of selecting the route.

The selection operation detector 13 outputs a selection operation signal indicating a detection result of the route selection operation to the guide display control apparatus 2.

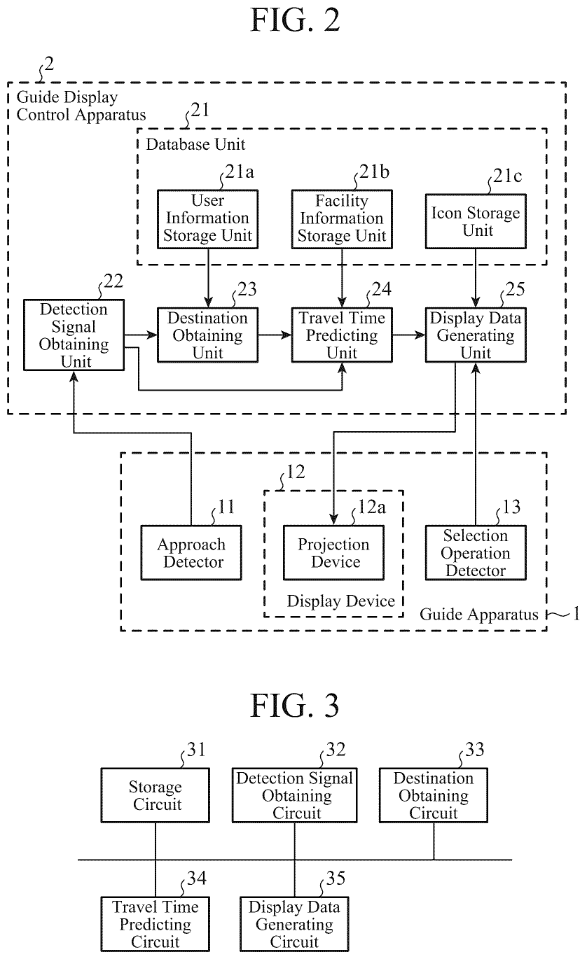

FIG. 2 is a configuration diagram illustrating the guide display control apparatus 2 according to the first embodiment.

FIG. 3 is a hardware configuration diagram illustrating hardware of the guide display control apparatus 2 according to the first embodiment.

The guide display control apparatus 2 illustrated in FIG. 2 includes a database unit 21, a detection signal obtaining unit 22, a destination obtaining unit 23, a travel time predicting unit 24, and a display data generating unit 25.

The database unit 21 is implemented by, for example, a storage circuit 31 illustrated in FIG. 3.

The database unit 21 includes a user information storage unit 21a, a facility information storage unit 21b, and an icon storage unit 21c.

Pieces of identification information of a plurality of facility users are registered in the user information storage unit 21a.

The user information storage unit 21a stores sets of destinations, the sets being associated with the respective pieces of identification information.

In a case where the facility is, for example, a hospital, the facility information storage unit 21b stores map data indicating each of the positions of a plurality of visiting departments of the hospital and passages in the hospital.

If the facility is, for example, a shopping mall, the facility information storage unit 21b stores map data indicating each of the positions of a plurality of stores of the shopping mall and passages in the shopping mall.

The icon storage unit 21c stores an icon such as an arrow to be used for generating a guide diagram.

The detection signal obtaining unit 22 is implemented by, for example, a detection signal obtaining circuit 32 illustrated in FIG. 3.

The detection signal obtaining unit 22 obtains a detection signal output from the approach detector 11 of the guide apparatus 1.

The detection signal obtaining unit 22 outputs the identification information included in the detection signal to the destination obtaining unit 23, and outputs the device number included in the detection signal to the travel time predicting unit 24.

The destination obtaining unit 23 is implemented by, for example, a destination obtaining circuit 33 illustrated in FIG. 3.

The destination obtaining unit 23 obtains the identification information from the detection signal obtaining unit 22.

The destination obtaining unit 23 obtains a plurality of destinations associated with the identification information, from the user information storage unit 21a.

The destination obtaining unit 23 outputs destination information indicating the plurality of destinations to the travel time predicting unit 24.

The travel time predicting unit 24 is implemented by, for example, a travel time predicting circuit 34 illustrated in FIG. 3.

The travel time predicting unit 24 obtains the destination information from the destination obtaining unit 23.

By referring to the map data stored in the facility information storage unit 21b, the travel time predicting unit 24 searches for routes to the respective destinations indicated by the destination information from the monitoring area of the guide apparatus 1 indicated by the device number included in the detection signal. An internal memory of the travel time predicting unit 24 stores the position of the monitoring area indicated by the device number.

The travel time predicting unit 24 predicts the travel time of the facility user from the monitoring area to each of the destinations on the basis of a search result of the route.

The travel time predicting unit 24 outputs, to the display data generating unit 25, the search result of the route and the travel time to each of the destinations.

The display data generating unit 25 is implemented by, for example, a display data generating circuit 35 illustrated in FIG. 3.

The display data generating unit 25 generates display data to display a guide diagram including arrows indicating the routes to the respective destinations searched for by the travel time predicting unit 24 and the travel time to each of the destinations predicted by the travel time predicting unit 24.

That is, the display data generating unit 25 obtains, from among the plurality of icons stored in the icon storage unit 21c, arrow icons indicating the routes to the respective destinations and obtains an icon indicating the travel time to each of the destinations. The display data generating unit 25 generates display data to display the guide diagram including the arrows indicating the routes to the respective destinations and the travel times to the respective destinations, by using the arrow icons and the icons indicating the travel times.

The display data generating unit 25 outputs the display data to the display device 12 of the guide apparatus 1.

The display data generating unit 25 determines the route selected by the facility user on the basis of the selection operation signal output from the selection operation detector 13.

The display data generating unit 25 regenerates display data to display the guide diagram including an arrow indicating the route selected by the selection operation detected by the selection operation detector 13 and the travel time to the destination related to the selected route.

The display data generating unit 25 outputs the regenerated display data to the display device 12 of the guide apparatus 1.

In FIG. 2, it is assumed that each of the database unit 21, the detection signal obtaining unit 22, the destination obtaining unit 23, the travel time predicting unit 24, and the display data generating unit 25, which are components of the guide display control apparatus 2, is implemented by dedicated hardware as illustrated in FIG. 3. That is, it is assumed that the guide display control apparatus 2 is implemented by the storage circuit 31, the detection signal obtaining circuit 32, the destination obtaining circuit 33, the travel time predicting circuit 34, and the display data generating circuit 35.

Here, the storage circuit 31 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

Each of the detection signal obtaining circuit 32, the destination obtaining circuit 33, the travel time predicting circuit 34, and the display data generating circuit 35 corresponds to, for example, a single circuit, a composite circuit, a programmed processor, a parallel-programmed processor, an application specific integrated circuit (ASIC), a field-programmable gate array (FPGA), or a combination thereof.

The components of the guide display control apparatus 2 are not limited to those implemented by dedicated hardware, and the guide display control apparatus 2 may be implemented by software, firmware, or a combination of software and firmware.

The software or firmware is stored in a memory of a computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

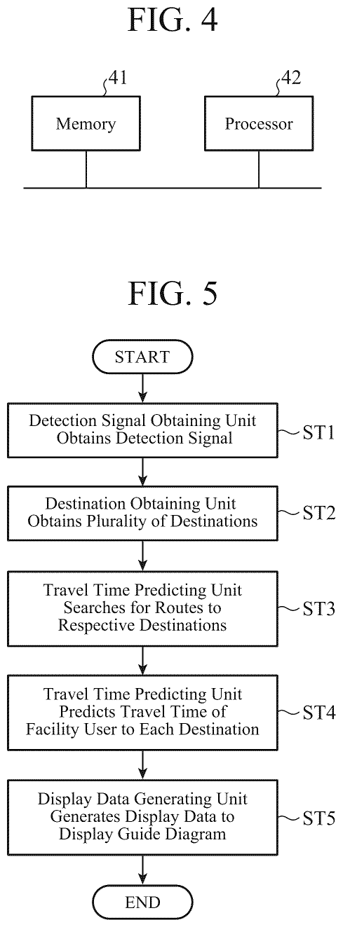

FIG. 4 is a hardware configuration diagram of a computer in a case where the guide display control apparatus 2 is implemented by software, firmware, or the like.

When the guide display control apparatus 2 is implemented by software, firmware, or the like, the database unit 21 is formed on a memory 41 of the computer. A program for causing the computer to execute each processing procedure performed in the detection signal obtaining unit 22, the destination obtaining unit 23, the travel time predicting unit 24, and the display data generating unit 25 is stored in the memory 41. Then, a processor 42 of the computer executes the program stored in the memory 41.

Further, FIG. 3 illustrates an example in which each of the components of the guide display control apparatus 2 is implemented by dedicated hardware, and FIG. 4 illustrates an example in which the guide display control apparatus 2 is implemented by software, firmware, or the like. However, this is merely an example, and some components in the guide display control apparatus 2 may be implemented by dedicated hardware, and the remaining components may be implemented by software, firmware, or the like.

Next, the operation of the route guiding system illustrated in FIG. 1 will be described.

FIG. 5 is a flowchart illustrating a guide display control method which is a processing procedure performed in the guide display control apparatus 2.

In the route guiding system illustrated in FIG. 1, for convenience of description, it is assumed that the users of the facility are a facility user U1 and a facility user U2, and the identification information of the facility user U1 is U1-12345 and the identification information of the facility user U2 is “U2-34567”. It is assumed that the facility which the facility users U1 and U2 use is a hospital.

It is assumed that, in a past visit to the hospital, the facility user U1 has made appointments with the internal medicine department and the dermatology department as departments to visit next time, and the appointment time with the internal medicine department is 10:00 and the appointment time with the dermatology department is 10:30. It is assumed that, in a past visit to the hospital, the facility user U2 has made appointments with the orthopedics department and the rehabilitation department as departments to visit next time, the appointment time with the orthopedics department is 10:20, and the appointment time with the rehabilitation department is 11:00.

The user information storage unit 21a stores the internal medicine department (appointment time: 10:00) and the dermatology department (appointment time: 10:30) as a plurality of destinations corresponding to the identification information “U1-12345”. In addition, the user information storage unit 21a stores the orthopedics department (appointment time: 10:20) and the rehabilitation department (appointment time: 11:00) as a plurality of destinations corresponding to the identification information “U2-34567”.

In the route guiding system illustrated in FIG. 1, the destination information indicating a plurality of destinations corresponding to the identification information includes appointment times. However, this is merely an example, and the destination information indicating the plurality of destinations corresponding to the identification information may omit to include the appointment times.

The guide apparatus 1 is installed, for example, in each of a lobby near an entrance of the hospital, the internal medicine department, the dermatology department, the orthopedics department, and the rehabilitation department. Further, the guide apparatus 1 is installed, for example, at each of a branch point of a passage from the lobby to the internal medicine department, a branch point of a passage from the lobby to the dermatology department, a branch point of a passage from the lobby to the orthopedics department, and a branch point of a passage from the lobby to the rehabilitation department. Further, the guide apparatus 1 is installed, for example, at each of a branch point of a passage from the internal medicine department to the dermatology department, a branch point of a passage from the dermatology department to the internal medicine department, a branch point of a passage from the orthopedics department to the rehabilitation department, and a branch point of a passage from the rehabilitation department to the orthopedics department.

In the route guiding system illustrated in FIG. 1, for example, it is assumed that a device number indicating the guide apparatus 1 whose monitoring area is the lobby near the entrance of the hospital is “A001”, a device number indicating the guide apparatus 1 whose monitoring area is the internal medicine department is “A002”, and a device number indicating the guide apparatus 1 whose monitoring area is the dermatology department is “A003”.

For example, the approach detector 11 of the guide apparatus 1 whose monitoring area is the lobby near the entrance of the hospital receives a radio wave transmitted from an RFID tag or the like owned by the facility user U1 when the facility user U1 enters the monitoring area. When the facility user U2 enters the monitoring area, the approach detector 11 receives a radio wave transmitted from an RFID tag or the like owned by the facility user U2.

For example, when receiving a radio wave transmitted from the RFID tag or the like owned by the facility user U1, the approach detector 11 determines that the facility user U1 has entered the monitoring area, and obtains the identification information “U1-12345” of the facility user U1 included in the received radio wave.

The approach detector 11 outputs a detection signal including the identification information “U1-12345” of the facility user U1 and the device number “A001” indicating the guide apparatus 1 to which the approach detector 11 belongs, to the guide display control apparatus 2.

For example, when receiving a radio wave transmitted from the RFID tag or the like owned by the facility user U2, the approach detector 11 determines that the facility user U2 has entered the monitoring area, and obtains the identification information “U2-34567” of the facility user U2 included in the received radio wave.

The approach detector 11 outputs a detection signal including the identification information “U2-34567” of the facility user U2 and the device number “A001” indicating the guide apparatus 1 to which the approach detector 11 belongs, to the guide display control apparatus 2.

The detection signal obtaining unit 22 of the guide display control apparatus 2 obtains a detection signal from the approach detector 11 of the guide apparatus 1 (step ST1 in FIG. 5).

When the facility user U1 has entered the monitoring area, the detection signal obtaining unit 22 outputs the identification information “U1-12345” included in the detection signal to the destination obtaining unit 23, and outputs the device number “A001” included in the detection signal to the travel time predicting unit 24.

Hereinafter, an example in which the facility user U1 enters the monitoring area will be described.

The destination obtaining unit 23 obtains the identification information “U1-12345” from the detection signal obtaining unit 22.

The destination obtaining unit 23 obtains each of the internal medicine department (appointment time: 10:00) and the dermatology department (appointment time: 10:30) from the user information storage unit 21a as a plurality of destinations associated with the identification information “U1-12345” (step ST2 in FIG. 5).

The destination obtaining unit 23 outputs destination information indicating the plurality of destinations to the travel time predicting unit 24.

The travel time predicting unit 24 obtains the destination information from the destination obtaining unit 23.

The travel time predicting unit 24 obtains the device number “A001” from the detection signal obtaining unit 22.

By referring to the map data stored in the facility information storage unit 21b, the travel time predicting unit 24 searches for routes from the monitoring area of the guide apparatus 1 indicated by the device number “A001” to the respective destinations indicated by the destination information (step ST3 in FIG. 5).

That is, by referring to the map data stored in the facility information storage unit 21b, the travel time predicting unit 24 searches for a route from the lobby to the internal medicine department in the hospital and a route from the lobby to the dermatology department in the hospital.

The travel time predicting unit 24 predicts the travel time of the facility user U1 from the monitoring area to each of the destinations on the basis of the search result of the route (step ST4 in FIG. 5).

That is, the travel time predicting unit 24 obtains a distance Lₐ of the route from the lobby to the internal medicine department in the hospital from the search result of the route to the internal medicine department, and divides the distance Lₐ by a walking speed V1 of the facility user U1 as expressed in the following Expression (1), thereby predicting a travel time Tₐ of the facility user U1 from the lobby to the internal medicine department in the hospital. The walking speed V may be stored in the internal memory of the travel time predicting unit 24 or may be given from the outside of the guide display control apparatus 2.

Tₐ=Lₐ/V1 (1)

Furthermore, the travel time predicting unit 24 obtains a distance L_{b} of the route from the lobby to the dermatology department in the hospital from the search result of the route to the dermatology department, and divides the distance L_{b} by the walking speed V1 of the facility user U1 as expressed in the following Expression (2), thereby predicting a travel time T_{b} of the facility user U1 from the lobby to the dermatology department in the hospital.

T_{b}=L_{b}/V1 (2)

The travel time predicting unit 24 outputs the route from the lobby to the internal medicine department in the hospital and the route from the lobby to the dermatology department in the hospital to the display data generating unit 25 as the search results of the routes.

In addition, the travel time predicting unit 24 outputs the travel time Tₐ from the lobby to the internal medicine department in the hospital and the travel time T_{b} from the lobby to the dermatology department in the hospital to the display data generating unit 25 as the travel times to the respective destinations.

The display data generating unit 25 obtains the search results of the routes and the travel times to the respective destinations from the travel time predicting unit 24.

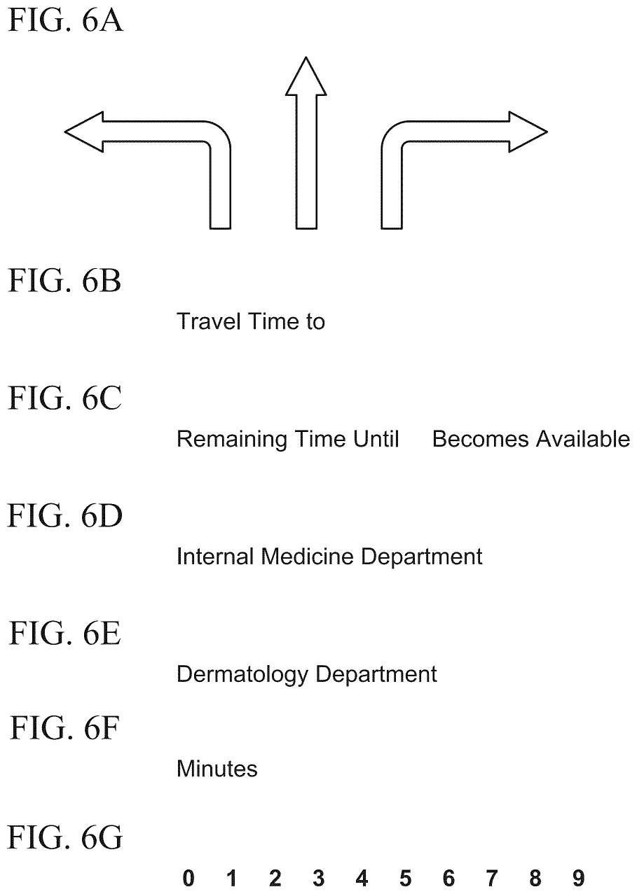

FIG. 6 is an explanatory diagram illustrating an example of icons stored in the icon storage unit 21c.

FIG. 6A illustrates an example of an arrow icon indicating a route to a destination. FIG. 6B illustrates a character string icon indicating a character string “travel time to” (hereinafter referred to as the “travel time character string icon”), and FIG. 6C illustrates a character string icon indicating a character string “remaining time until becomes available” (hereinafter referred to as the “remaining time character string icon”).

FIG. 6D illustrates a character string icon indicating a character string “internal medicine department” (hereinafter referred to as the “internal medicine department character string icon”), and FIG. 6E illustrates a character string icon indicating a character string “dermatology department” (hereinafter referred to as the “dermatology department character string icon”).

FIG. 6F illustrates a character icon indicating characters “minutes” (hereinafter referred to as the “minutes character icon”).

FIG. 6G illustrates number icons indicating numbers “0”, “1”, “2”, “3”, “4”, “5”, “6”, “7”, “8”, and “9”.

The icons illustrated in FIGS. 6A to 6G are examples of icons stored in the icon storage unit 21c, and icons not illustrated in FIGS. 6A to 6G are also stored in the icon storage unit 21c.

The display data generating unit 25 generates display data to display a guide diagram including the arrows indicating the routes to the respective destinations searched for by the travel time predicting unit 24 and the travel times of the facility user U1 to the respective destinations predicted by the travel time predicting unit 24, by using the icons stored in the icon storage unit 21c (step ST5 in FIG. 5).

That is, the display data generating unit 25 obtains arrow icons indicating the routes to the respective destinations from among the plurality of icons stored in the icon storage unit 21c. When the direction of the route from the lobby to the internal medicine department is, for example, a straight direction, the display data generating unit 25 selects an arrow icon whose arrow direction is a straight direction (hereinafter referred to as the “straight arrow icon”) from among a plurality of arrow icons stored in the icon storage unit 21c. Furthermore, when the direction of the route from the lobby to the dermatology department is, for example, a right turn direction, the display data generating unit 25 selects an arrow icon whose arrow direction is a right turn direction (hereinafter referred to as the “right turn arrow icon”) from among the plurality of arrow icons stored in the icon storage unit 21c.

The display data generating unit 25 obtains an icon indicating the travel time to each of the destinations from among the plurality of icons stored in the icon storage unit 21c. When the travel time from the lobby to the internal medicine department is, for example, 3 minutes, the display data generating unit 25 selects the internal medicine department character string icon and the travel time character string icon from among the plurality of character string icons stored in the icon storage unit 21c. In addition, the display data generating unit 25 selects the minutes character icon and a character icon indicating the characters “is” from among the plurality of character icons stored in the icon storage unit 21c, and selects the number icon indicating the number “3” from among the plurality of number icons stored in the icon storage unit 21c.

When the travel time from the lobby to the dermatology department is, for example, 5 minutes, the display data generating unit 25 selects the dermatology department character string icon and the travel time character string icon from among the plurality of character string icons stored in the icon storage unit 21c. In addition, the display data generating unit 25 selects the minutes character icon and the character icon indicating the characters “is” from among the plurality of character icons stored in the icon storage unit 21c, and selects the number icon indicating the number “5” from among the plurality of number icons stored in the icon storage unit 21c.

The display data generating unit 25 generates a first time guide icon indicating “travel time to internal medicine department is 3 minutes” by combining the internal medicine department character string icon, the travel time character string icon, the character icon indicating the characters “is”, the number icon indicating the number “3”, and the minutes character icon.

Further, the display data generating unit 25 generates a second time guide icon indicating “travel time to dermatology department is 5 minutes” by combining the dermatology department character string icon, the travel time character string icon, the character icon indicating the characters “is”, the number icon indicating the number “5”, and the minutes character icon.

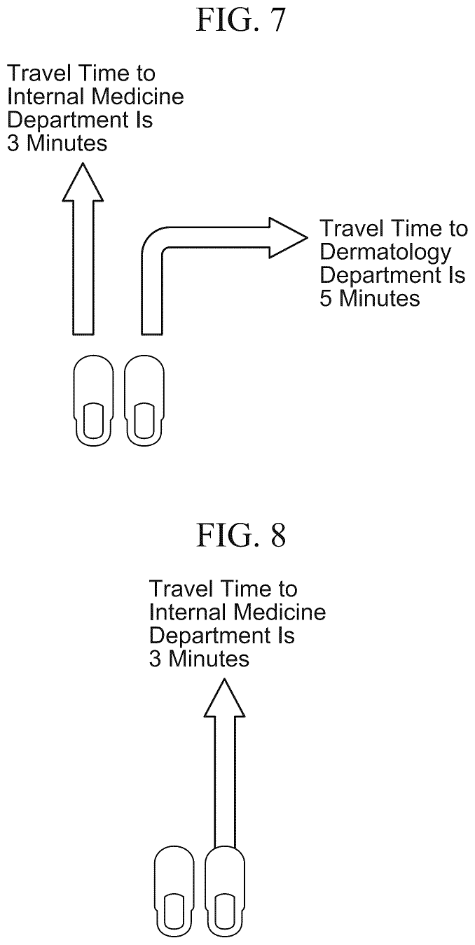

As illustrated in FIG. 7, the display data generating unit 25 generates display data to display a guide diagram including the straight arrow icon, the right turn arrow icon, the first time guide icon, and the second time guide icon.

FIG. 7 is an explanatory diagram illustrating an example of a guide diagram in a monitoring area.

In FIG. 7, a shoes icon indicates the current position of the facility user U1.

In the guide diagram illustrated in FIG. 7, the first time guide icon is disposed in the vicinity of the straight arrow icon, and the second time guide icon is disposed in the vicinity of the right turn arrow icon.

The display data generating unit 25 outputs the display data to the projection device 12a of the guide apparatus 1.

The projection device 12a obtains the display data from the display data generating unit 25.

As illustrated in FIG. 7, the projection device 12a projects the guide diagram onto a floor surface or the like of the monitoring area in accordance with the display data.

When looking at the guide diagram projected on the floor surface or the like of the monitoring area, the facility user U1 can see that the travel time to the internal medicine department is 3 minutes and the facility user U1 can go straight to the internal medicine department. Further, when looking at the guide diagram projected on the floor surface or the like of the monitoring area, the facility user U1 can see that the travel time to the dermatology department is 5 minutes and the facility user U1 can go to the dermatology department by turning right.

The selection operation detector 13 detects the selection operation by the facility user U1 to select a route to one of a plurality of destinations from among the routes to the destinations after the guide diagram is projected on the floor surface or the like of the monitoring area by the projection device 12a.

When the facility user U1 steps on the straight arrow icon included in the guide diagram, the selection operation detector 13 determines that the facility user U1 has performed an operation of selecting a route to the internal medicine department.

When the facility user U1 steps on the right turn arrow icon included in the guide diagram, the selection operation detector 13 determines that the facility user U1 has performed an operation of selecting a route to the dermatology department.

The selection operation detector 13 outputs a selection operation signal indicating a detection result of the route selection operation to the display data generating unit 25 of the guide display control apparatus 2.

The display data generating unit 25 obtains the selection operation signal from the selection operation detector 13.

The display data generating unit 25 determines the route selected by the facility user U1 on the basis of the selection operation signal output from the selection operation detector 13.

That is, when the detection result indicated by the selection operation signal indicates that the route to the internal medicine department is selected, the display data generating unit 25 regenerates display data to display a guide diagram including the straight arrow icon and the first time guide icon.

When the detection result indicated by the selection operation signal indicates that the route to the dermatology department is selected, the display data generating unit 25 regenerates display data to display a guide diagram including the right turn arrow icon and the second time guide icon.

The display data generating unit 25 outputs the regenerated display data to the projection device 12a of the guide apparatus 1.

The projection device 12a obtains the display data after the regeneration from the display data generating unit 25.

As illustrated in FIG. 8, the projection device 12a projects the guide diagram onto the floor surface or the like of the monitoring area in accordance with the display data after the regeneration.

FIG. 8 is an explanatory diagram illustrating an example of the guide diagram in the monitoring area.

In the example of FIG. 8, the route to the internal medicine department is selected, and thus the guide on the route to the dermatology department is deleted.

In the first embodiment described above, the guide display control apparatus 2 includes: the detection signal obtaining unit 22 to obtain a detection signal including identification information of a facility user who has entered a monitoring area from the approach detector 11 that detects entry of the facility user into the monitoring area; the destination obtaining unit 23 to obtain a plurality of destinations associated with the identification information included in the detection signal obtained by the detection signal obtaining unit 22; the travel time predicting unit 24 to search for routes from the monitoring area to the respective destinations obtained by the destination obtaining unit 23, and predict a travel time of the facility user from the monitoring area to each of the destinations on the basis of a search result of the routes; and the display data generating unit 25 to generate display data to display a guide diagram including arrows each indicating a corresponding one of the routes to the respective destinations searched for by the travel time predicting unit 24 and the travel time to each of the destinations predicted by the travel time predicting unit 24. Therefore, the guide display control apparatus 2 can show the routes to the respective destinations.

### Second Embodiment

In a second embodiment, a guide display control apparatus 2 including an associating unit 26 to obtain identification information of a facility user and a destination, and associate the obtained identification information with the obtained destination will be described.

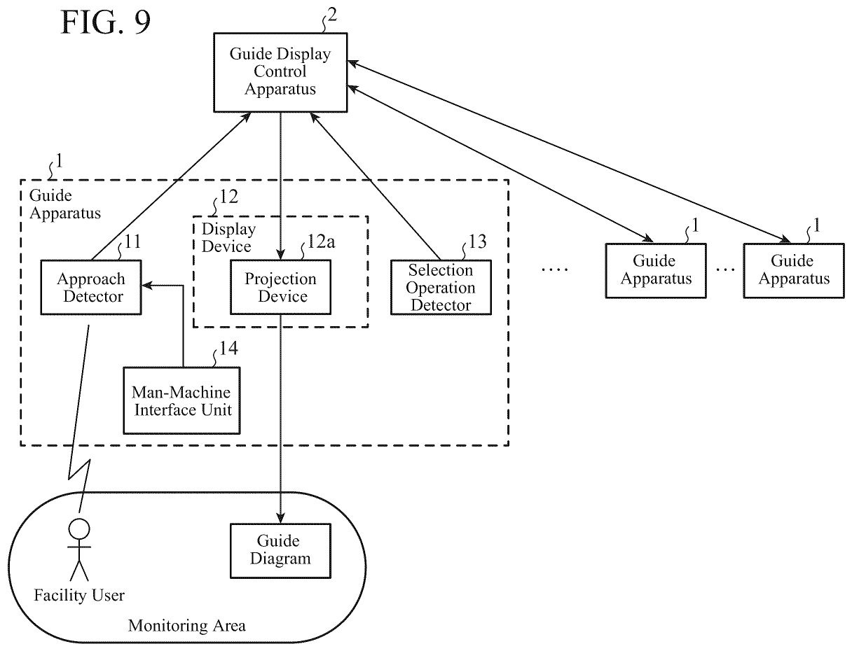

FIG. 9 is a configuration diagram illustrating a route guiding system according to the second embodiment.

The route guiding system illustrated in FIG. 9 includes a guide apparatus 1 and the guide display control apparatus 2.

The guide apparatus 1 includes the approach detector 11, the display device 12, the selection operation detector 13, and a man-machine interface unit 14.

The man-machine interface unit 14 is implemented by a keyboard, a mouse, a touch panel, or the like.

The man-machine interface unit 14 receives a destination setting operation by the facility user and outputs destination information indicating the destination to the approach detector 11.

When the destination information is output from the man-machine interface unit 14, the approach detector 11 outputs a detection signal including the identification information of the facility user and the destination information to the guide display control apparatus 2. The detection signal obtaining unit 22 of the guide display control apparatus 2 obtains the detection signal output from the approach detector 11. When the detection signal includes each of the identification information and the destination information, the detection signal obtaining unit 22 outputs each of the identification information and the destination information to the associating unit 26.

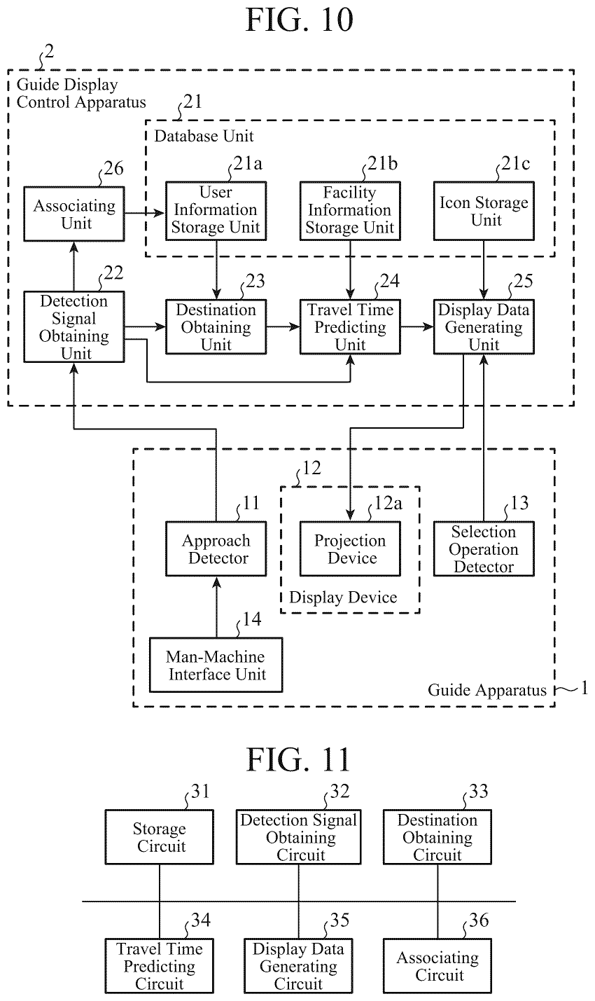

FIG. 10 is a configuration diagram illustrating the guide display control apparatus 2 according to the second embodiment.

FIG. 11 is a hardware configuration diagram illustrating hardware of the guide display control apparatus 2 according to the second embodiment.

In FIGS. 10 and 11, the same reference numerals as those in FIGS. 2 and 3 denote the same or corresponding parts, and thus description thereof is omitted.

The guide display control apparatus 2 illustrated in FIG. 10 includes the database unit 21, the detection signal obtaining unit 22, the destination obtaining unit 23, the travel time predicting unit 24, the display data generating unit 25, and the associating unit 26.

The associating unit 26 is implemented by, for example, an associating circuit 36 illustrated in FIG. 11.

The associating unit 26 obtains each of the identification information and the destination information from the detection signal obtaining unit 22.

The associating unit 26 causes each of the identification information and the destination information to be stored in the user information storage unit 21a.

In FIG. 10, it is assumed that each of the database unit 21, the detection signal obtaining unit 22, the destination obtaining unit 23, the travel time predicting unit 24, the display data generating unit 25, and the associating unit 26, which are components of the guide display control apparatus 2, is implemented by dedicated hardware as illustrated in FIG. 11. That is, it is assumed that the guide display control apparatus 2 is implemented by the storage circuit 31, the detection signal obtaining circuit 32, the destination obtaining circuit 33, the travel time predicting circuit 34, the display data generating circuit 35, and the associating circuit 36.

Each of the detection signal obtaining circuit 32, the destination obtaining circuit 33, the travel time predicting circuit 34, the display data generating circuit 35, and the associating circuit 36 corresponds to, for example, a single circuit, a composite circuit, a programmed processor, a parallel-programmed processor, an ASIC, an FPGA, or a combination thereof.

The components of the guide display control apparatus 2 are not limited to those implemented by dedicated hardware, and the guide display control apparatus 2 may be implemented by software, firmware, or a combination of software and firmware.

When the guide display control apparatus 2 is implemented by software, firmware, or the like, the database unit 21 is formed on the memory 41 of the computer. A program for causing the computer to execute each processing procedure performed in the detection signal obtaining unit 22, the destination obtaining unit 23, the travel time predicting unit 24, the display data generating unit 25, and the associating unit 26 is stored in the memory 41 illustrated in FIG. 4. Then, the processor 42 illustrated in FIG. 4 executes the program stored in the memory 41.

Further, FIG. 11 illustrates an example in which each of the components of the guide display control apparatus 2 is implemented by dedicated hardware, and FIG. 4 illustrates an example in which the guide display control apparatus 2 is implemented by software, firmware, or the like. However, this is merely an example, and some components in the guide display control apparatus 2 may be implemented by dedicated hardware, and the remaining components may be implemented by software, firmware, or the like.

Next, the operation of the route guiding system illustrated in FIG. 9 will be described. It is similar to that of the route guiding system illustrated in FIG. 1 except for the man-machine interface unit 14 and the associating unit 26, and thus the operation of the man-machine interface unit 14 and the associating unit 26 will be mainly described here.

In the route guiding system illustrated in FIG. 9, the facility user U1 can set the destination freely.

In the route guiding system illustrated in FIG. 9, as in the route guiding system illustrated in FIG. 1, sets of destinations associated with respective pieces of identification information of facility users may be stored in advance in the user information storage unit 21a.

For example, the facility user U1 who has entered the monitoring area can set a destination in the facility by operating the man-machine interface unit 14.

The man-machine interface unit 14 receives a destination setting operation by the facility user U1 and outputs destination information indicating the destination to the approach detector 11.

When the approach detector 11 can receive the radio wave transmitted from the possessed object of the facility user, the approach detector 11 determines that the facility user has entered the monitoring area, and outputs a detection signal including the identification information “U1-12345” of the facility user and the device number to the guide display control apparatus 2.

Upon receiving the destination information from the man-machine interface unit 14, the approach detector 11 outputs a detection signal including the identification information “U1-12345” of the facility user U1 and the destination information to the guide display control apparatus 2.

The detection signal obtaining unit 22 obtains the detection signal output from approach detector 11.

When the detection signal includes the identification information “U1-12345” and the device number, the detection signal obtaining unit 22 outputs the identification information “U1-12345” to the destination obtaining unit 23, and outputs the device number to the travel time predicting unit 24.

When the detection signal includes each of the identification information “U1-12345” and the destination information, the detection signal obtaining unit 22 outputs each of the identification information “U1-12345” and the destination information to the associating unit 26.

The associating unit 26 obtains each of the identification information and the destination information from the detection signal obtaining unit 22.

The associating unit 26 causes each of the identification information and the destination information to be stored in the user information storage unit 21a.

When the destination indicated by the destination information is, for example, the gynecology department, the destinations associated with the identification information “U1-12345” in the user information storage unit 21a become the internal medicine department, the dermatology department, and the gynecology department. In this way, the destination of the facility user U1 is added.

The operation thereafter is similar to that of the route guiding system illustrated in FIG. 1, and thus detailed description thereof will be omitted.

In the above-described second embodiment, the guide display control apparatus 2 illustrated in FIG. 10 is configured to include the associating unit 26 that obtains the identification information and the destination of the facility user, and associates the obtained identification information with the obtained destination. Therefore, the guide display control apparatus 2 illustrated in FIG. 10 can show routes to respective destinations as does the guide display control apparatus 2 illustrated in FIG. 2, and in addition, the facility user can set a destination inside the facility.

In the route guiding system illustrated in FIG. 9, the man-machine interface unit 14 receives the destination setting operation and outputs the destination information indicating the destination to the approach detector 11, and the approach detector 11 outputs the detection signal including the destination information to the associating unit 26. However, this is merely an example. If the possessed object of the facility user is, for example, a mobile terminal and the associating unit 26 has a wireless communication function, the mobile terminal may transmit the identification information of the facility user and the destination information indicating the destination to the associating unit 26.

### Third Embodiment

In the route guiding systems according to the first and second embodiments, the travel time predicting unit 24 predicts the travel time of the facility user from the monitoring area to each of the destinations.

In a third embodiment, a description will be given of a route guiding system in which, when each of the destinations obtained by the destination obtaining unit 23 is a destination with a limited use time, the travel time predicting unit 24 calculates a remaining time until the time limit for use of each of the destinations instead of predicting a travel time to the destination.

A configuration of the route guiding system according to the third embodiment is similar to the configurations of the route guiding systems according to the first and second embodiments, and a configuration diagram illustrating the route guiding system according to the third embodiment is FIG. 1 or FIG. 9.

A configuration of a guide display control apparatus 2 according to the third embodiment is similar to the configurations of the guide display control apparatuses 2 according to the first and second embodiments, and a configuration diagram illustrating the guide display control apparatus 2 according to the third embodiment is FIG. 2 or FIG. 10.

The operation of the route guiding system according to the third embodiment will be described.

In the third embodiment, it is assumed that the facility user U1 enters the monitoring area. In addition, the user information storage unit 21a stores the internal medicine department (appointment time: 10:00), the dermatology department (appointment time: 10:30), and a 24 hour store as a plurality of destinations corresponding to the identification information “U1-12345” of the facility user U1.

Each of the internal medicine department and the dermatology department is a destination with a limited use time since appointment times are set. The 24 hour store is a destination with no limitation on the use time.

In the route guiding system according to the third embodiment, the destination information indicating some of the plurality of destinations corresponding to the identification information includes appointment times. However, this is merely an example, and destination information indicating all destinations may include appointment times.

The destination obtaining unit 23 obtains the identification information “U1-12345” from the detection signal obtaining unit 22.

The destination obtaining unit 23 obtains, from the user information storage unit 21a, each of the internal medicine department (appointment time: 10:00), the dermatology department (appointment time: 10:30), and the 24 hour store as a plurality of destinations associated with the identification information “U1-12345”.

The destination obtaining unit 23 outputs destination information indicating the plurality of destinations to the travel time predicting unit 24.

The travel time predicting unit 24 obtains the destination information from the destination obtaining unit 23.

The travel time predicting unit 24 obtains the device number “A001” from the detection signal obtaining unit 22.

By referring to the map data stored in the facility information storage unit 21b, the travel time predicting unit 24 searches for routes to the respective destinations from the monitoring area of the guide apparatus 1 indicated by the device number “A001”.

That is, by referring to the map data stored in the facility information storage unit 21b, the travel time predicting unit 24 searches for a route to the internal medicine department, a route to the dermatology department, and a route to the store.

The travel time predicting unit 24 calculates a remaining time Trₐ until the appointment time by subtracting the current time T_{now} from 10:00, which is the appointment time with the internal medicine department, since the internal medicine department as the destination is a destination with a limited use time. For example, when the current time T_{now} is 9:30, the remaining time Trₐ is 30 minutes.

Further, since the dermatology department as the destination is a destination with a limited use time, the travel time predicting unit 24 calculates a remaining time Tr_{b} until the appointment time by subtracting the current time T_{mow} from 10:30, which is the appointment time with the dermatology department. For example, when the current time T_{now} is 9:30, the remaining time Tr_{b} is 60 minutes.

Since the store is a destination with no limitation on the use time, the travel time predicting unit 24 calculates a travel time Tc to reach the store by a method similar to the method described in the first embodiment.

The travel time predicting unit 24 outputs the remaining time Trₐ, the remaining time Tr_{b}, and the travel time Tc to the display data generating unit 25.

The display data generating unit 25 obtains arrow icons indicating routes to the respective destinations from among the plurality of icons stored in the icon storage unit 21c. When the direction of the route from the lobby to the internal medicine department is, for example, a straight direction, the display data generating unit 25 selects the straight arrow icon from among the plurality of arrow icons stored in the icon storage unit 21c. Further, when the direction of the route from the lobby to the dermatology department is, for example, a right turn direction, the display data generating unit 25 selects the right turn arrow icon from the plurality of arrow icons stored in the icon storage unit 21c. In addition, when the direction of the route to the store is, for example, a left turn direction, the display data generating unit 25 selects an arrow icon whose arrow direction is a left turn direction (hereinafter referred to as the “left turn arrow icon”) from among the plurality of arrow icons stored in the icon storage unit 21c.

The display data generating unit 25 generates a third time guide icon indicating “remaining time until internal medicine department becomes available is 30 minutes” by combining the internal medicine department character string icon, the remaining time character string icon, the character icon indicating the characters “is”, the number icon indicating the number “3”, the number icon indicating the number “0”, and the minutes character icon.

The display data generating unit 25 generates a fourth time guide icon indicating “remaining time until dermatology department becomes available is 60 minutes” by combining the dermatology department character string icon, the remaining time character string icon, the character icon indicating the characters “is”, the number icon indicating the number “6”, the number icon indicating the number “0”, and the minutes character icon.

Further, when the travel time Tc is, for example, 8 minutes, the display data generating unit 25 generates a fifth time guide icon indicating “travel time to store is 8 minutes” by combining the character string icon indicating the character string “store”, the travel time character string icon, the character icon indicating the characters “is”, the number icon indicating the number “8”, and the minutes character icon.

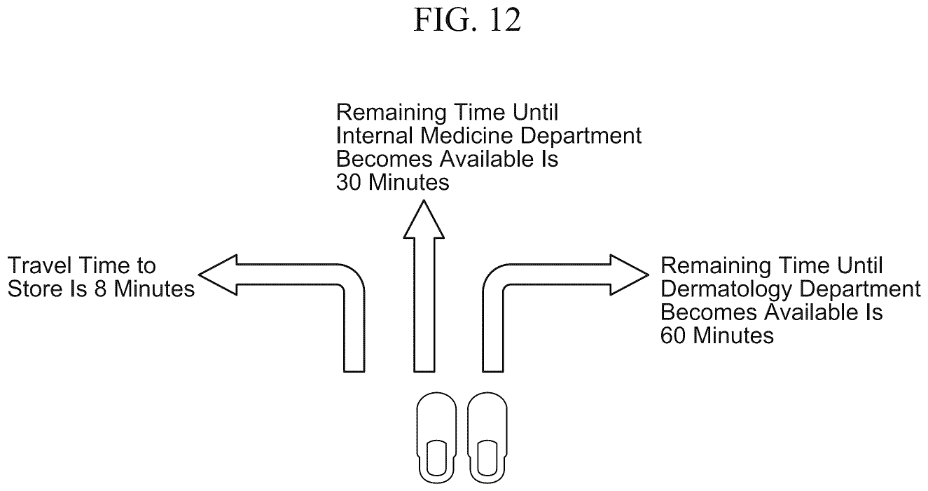

As illustrated in FIG. 12, the display data generating unit 25 generates display data to display a guide diagram including the straight arrow icon, the right turn arrow icon, the left turn arrow icon, the third time guide icon, the fourth time guide icon, and the fifth time guide icon.

The display data generating unit 25 outputs the display data to the projection device 12a of the guide apparatus 1.

FIG. 12 is an explanatory diagram illustrating an example of the guide diagram in the monitoring area.

The projection device 12a obtains the display data from the display data generating unit 25.

As illustrated in FIG. 12, the projection device 12a projects the guide diagram onto a floor surface or the like of the monitoring area in accordance with the display data.

When looking at the guide diagram projected on the floor surface or the like of the monitoring area, the facility user U1 can see that the remaining time until the internal medicine department becomes available is 30 minutes and the facility user U1 can go straight to the internal medicine department. When looking at the guide diagram projected on the floor surface or the like of the monitoring area, the facility user U1 can see that the remaining time until the dermatology department becomes available is 60 minutes and the facility user U1 can go to the dermatology department by turning right. Further, when looking at the guide diagram projected on the floor surface or the like of the monitoring area, the facility user U1 can see that the travel time to the store is 8 minutes and the facility user U1 can go to the store by turning left.

In the above-described third embodiment, the guide display control apparatus 2 is configured in such a way that the travel time predicting unit 24 calculates, when each of the destinations obtained by the destination obtaining unit 23 is a destination with a limited use time, the remaining time until the time limit for use of the destination instead of predicting the travel time, and the display data generating unit 25 generates display data to display a guide diagram including arrows each indicating a corresponding one of the routes to the respective destinations searched for by the travel time predicting unit 24 and the remaining time for each of the destinations calculated by the travel time predicting unit 24. Therefore, the guide display control apparatus 2 according to the third embodiment can show routes to respective destinations as does the guide display control apparatus 2 according to the first embodiment, and in addition, can show a remaining time until the time limit for use of each of the destinations.

### Fourth Embodiment

In a fourth embodiment, a guide display control apparatus 2 will be described that includes a travel time predicting unit 27 that predicts a travel time of a facility user from a monitoring area to each of destinations and also predicts a travel time of the facility user from the monitoring area to a sub destination by using, as the sub destination, a point different from the destinations obtained by the destination obtaining unit 23.

A configuration of a route guiding system according to the fourth embodiment is similar to the configurations of the route guiding systems according to the first and second embodiments, and a configuration diagram illustrating the route guiding system according to the fourth embodiment is FIG. 1 or FIG. 9.

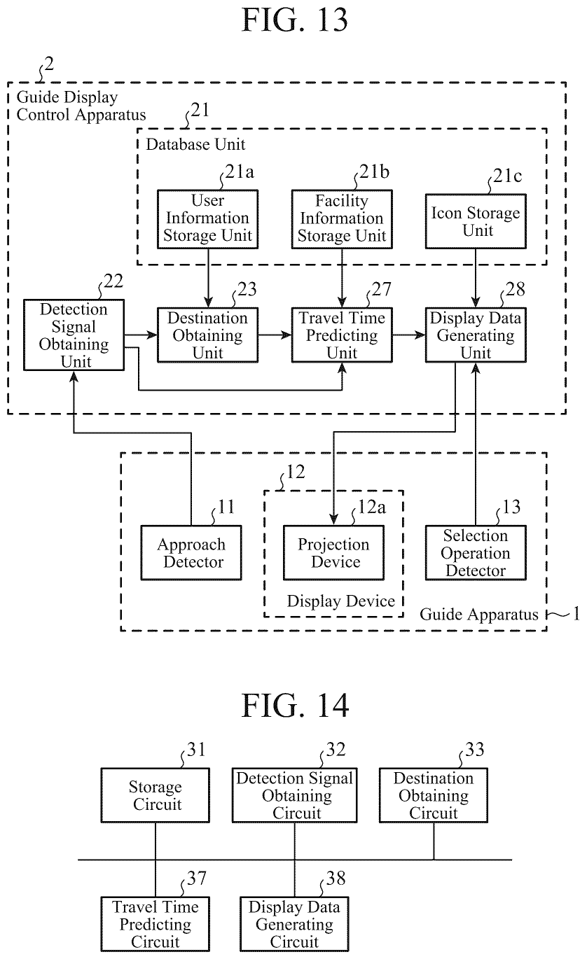

FIG. 13 is a configuration diagram illustrating the guide display control apparatus 2 according to the fourth embodiment.

FIG. 14 is a hardware configuration diagram illustrating hardware of the guide display control apparatus 2 according to the fourth embodiment.

In FIGS. 13 and 14, the same reference numerals as those in FIGS. 2 and 3 denote the same or corresponding parts, and thus description thereof is omitted.

The guide display control apparatus 2 illustrated in FIG. 13 includes the database unit 21, the detection signal obtaining unit 22, the destination obtaining unit 23, the travel time predicting unit 27, and a display data generating unit 28.

The travel time predicting unit 27 is implemented by, for example, a travel time predicting circuit 37 illustrated in FIG. 14.

The travel time predicting unit 27 obtains destination information from the destination obtaining unit 23, ss does the travel time predicting unit 24 illustrated in FIG. 2.

By referring to the map data stored in the facility information storage unit 21b, the travel time predicting unit 27 searches for routes from the monitoring area of the guide apparatus 1 indicated by the device number included in the detection signal to the respective destinations indicated by the destination information, as does the travel time predicting unit 24 illustrated in FIG. 2.

The travel time predicting unit 27 outputs a search result of the routes to the respective destinations and a travel time to each of the destinations to the display data generating unit 28.

Unlike the travel time predicting unit 24 illustrated in FIG. 2, by referring to the map data stored in the facility information storage unit 21b, the travel time predicting unit 27 sets a point different from the destinations obtained by the destination obtaining unit 23 among a plurality of points in the facility as a sub destination. The travel time predicting unit 27 searches for a route from the monitoring area to the sub destination by referring to the map data stored in the facility information storage unit 21b. An internal memory of the travel time predicting unit 27 stores the position of the monitoring area indicated by the device number.

Hereinafter, in the present description, a destination simply described as a “destination” indicates a destination stored in the user information storage unit 21a and is different from a sub destination.

Unlike the travel time predicting unit 24 illustrated in FIG. 2, the travel time predicting unit 27 predicts the travel time of the facility user from the monitoring area to the sub destination on the basis of the search result of the route to the sub destination.

The travel time predicting unit 27 outputs the search result of the route to the sub destination and the travel time to the sub destination to the display data generating unit 28.

The display data generating unit 28 is implemented by, for example, a display data generating circuit 38 illustrated in FIG. 14.

The display data generating unit 28 obtains, from the travel time predicting unit 27, the search result of the routes to the respective destinations, the travel time to each of the destinations, the search result of the route to the sub destination, and the travel time to the sub destination.

The display data generating unit 28 generates display data to display a guide diagram including arrows indicating the routes to the respective destinations searched for by the travel time predicting unit 27, an arrow indicating the route to the sub destination searched for by the travel time predicting unit 27, the travel time to each of the destinations predicted by the travel time predicting unit 27, and the travel time to the sub destination predicted by the travel time predicting unit 27.

The display data generating unit 28 outputs the display data to the projection device 12a of the guide apparatus 1.

In the guide display control apparatus 2 illustrated in FIG. 13, the travel time predicting unit 27 and the display data generating unit 28 are applied to the guide display control apparatus 2 illustrated in FIG. 2. However, this is merely an example, and the travel time predicting unit 27 and the display data generating unit 28 may be applied to the guide display control apparatus 2 illustrated in FIG. 10.

In FIG. 13, it is assumed that each of the database unit 21, the detection signal obtaining unit 22, the destination obtaining unit 23, the travel time predicting unit 27, and the display data generating unit 28, which are components of the guide display control apparatus 2, is implemented by dedicated hardware as illustrated in FIG. 14. That is, it is assumed that the guide display control apparatus 2 is implemented by the storage circuit 31, the detection signal obtaining circuit 32, the destination obtaining circuit 33, the travel time predicting circuit 37, and the display data generating circuit 38.

Each of the detection signal obtaining circuit 32, the destination obtaining circuit 33, the travel time predicting circuit 37, and the display data generating circuit 38 corresponds to, for example, a single circuit, a composite circuit, a programmed processor, a parallel-programmed processor, an ASIC, an FPGA, or a combination thereof.

The components of the guide display control apparatus 2 are not limited to those implemented by dedicated hardware, and the guide display control apparatus 2 may be implemented by software, firmware, or a combination of software and firmware.

When the guide display control apparatus 2 is implemented by software, firmware, or the like, the database unit 21 is formed on the memory 41 of the computer. A program for causing the computer to execute each processing procedure performed in the detection signal obtaining unit 22, the destination obtaining unit 23, the travel time predicting unit 27, and the display data generating unit 28 is stored in the memory 41 illustrated in FIG. 4. Then, the processor 42 illustrated in FIG. 4 executes the program stored in the memory 41.

Further, FIG. 14 illustrates an example in which each of the components of the guide display control apparatus 2 is implemented by dedicated hardware, and FIG. 4 illustrates an example in which the guide display control apparatus 2 is implemented by software, firmware, or the like. However, this is merely an example, and some components in the guide display control apparatus 2 may be implemented by dedicated hardware, and the remaining components may be implemented by software, firmware, or the like.

Next, the operation of the guide display control apparatus 2 illustrated in FIG. 13 will be described. It is similar to that of the guide display control apparatus 2 illustrated in FIG. 2 except for the travel time predicting unit 27 and the display data generating unit 28, and thus the operation of the travel time predicting unit 27 and the display data generating unit 28 will be mainly described here.

By referring to the map data stored in the facility information storage unit 21b, the travel time predicting unit 27 searches for routes from the monitoring area of the guide apparatus 1 indicated by the device number included in the detection signal to the respective destinations, as does the travel time predicting unit 24 illustrated in FIG. 2.

The travel time predicting unit 27 outputs a search result of the routes to the respective destinations and a travel time to each of the destinations to the display data generating unit 28.

By referring to the map data stored in the facility information storage unit 21b, the travel time predicting unit 27 sets a point different from the destinations obtained by the destination obtaining unit 23 among a plurality of points in the facility as a sub destination.

For example, the travel time predicting unit 27 sets, as a sub destination, a point closest to the monitoring area among top several points with a large number of visitors among a plurality of points in the facility. Here, it is assumed that the number of visitors at each of the plurality of points in the facility is included in the map data.

The travel time predicting unit 27 is not limited to the one that sets the point closest to the monitoring area as the sub destination, and for example, a point with the largest number of visitors may be set as the sub destination.

The travel time predicting unit 27 searches for a route from the monitoring area to the sub destination by referring to the map data stored in the facility information storage unit 21b.

The travel time predicting unit 27 predicts a travel time from the monitoring area to the sub destination on the basis of the search result of the route to the sub destination. That is, the travel time predicting unit 27 obtains the distance of the route from the monitoring area to the sub destination from the search result of the route to the sub destination, and divides the obtained distance by the walking speed V1 of the facility user U1 to predict the travel time from the monitoring area to the sub destination.

The travel time predicting unit 27 outputs the search result of the route to the sub destination and the travel time to the sub destination to the display data generating unit 28.

The display data generating unit 28 obtains, from the travel time predicting unit 27, the search result of the routes to the respective destinations, the travel time to each of the destinations, the search result of the route to the sub destination, and the travel time to the sub destination.

The display data generating unit 28 obtains arrow icons indicating the routes to the respective destinations and an arrow icon indicating the route to the sub destination from among the plurality of icons stored in the icon storage unit 21c. When the direction of the route to the internal medicine department as the destination is, for example, a straight direction, the display data generating unit 28 selects the straight arrow icon from among the plurality of arrow icons stored in the icon storage unit 21c. Further, when the direction of the route to the dermatology department as the destination is, for example, a right turn direction, the display data generating unit 28 selects the right turn arrow icon from the plurality of arrow icons stored in the icon storage unit 21c.

For example, when the sub destination is a flower shop and the direction of the route to the flower shop is a left turn direction, the display data generating unit 28 selects the left turn arrow icon from the plurality of arrow icons stored in the icon storage unit 21c.

The display data generating unit 28 obtains an icon indicating the travel time to each of the destinations and an icon indicating the travel time to the sub destination from among the plurality of icons stored in the icon storage unit 21c.

When the travel time to the internal medicine department as the destination is, for example, 3 minutes, the display data generating unit 28 selects the internal medicine department character string icon and the travel time character string icon from among the plurality of character string icons stored in the icon storage unit 21c. Further, the display data generating unit 28 selects the minutes character icon and the character icon indicating the characters “is” from among the plurality of character icons stored in the icon storage unit 21c, and selects the number icon indicating the number “3” from among the plurality of number icons stored in the icon storage unit 21c.

When the travel time to the dermatology department as the destination is, for example, 5 minutes, the display data generating unit 28 selects the dermatology department character string icon and the travel time character string icon from among the plurality of character string icons stored in the icon storage unit 21c. Further, the display data generating unit 28 selects the minutes character icon and the character icon indicating the characters “is” from among the plurality of character icons stored in the icon storage unit 21c, and selects the number icon indicating the number “5” from among the plurality of number icons stored in the icon storage unit 21c.

When the travel time to the flower shop as the sub destination is, for example, 6 minutes, the display data generating unit 28 selects a character string icon indicating the character string “flower shop” and the travel time character string icon from among the plurality of character string icons stored in the icon storage unit 21c. Further, the display data generating unit 28 selects the minutes character icon and the character icon indicating the characters “is” from among the plurality of character icons stored in the icon storage unit 21c, and selects the number icon indicating the number “6” from among the plurality of number icons stored in the icon storage unit 21c.

The display data generating unit 28 generates the first time guide icon indicating “travel time to internal medicine department is 3 minutes” by combining the internal medicine department character string icon, the travel time character string icon, the character icon indicating “is”, the number icon indicating the number “3”, and the minutes character icon.

Further, the display data generating unit 28 generates the second time guide icon indicating “travel time to dermatology department is 5 minutes” by combining the dermatology department character string icon, the travel time character string icon, the character icon indicating “is”, the number icon indicating the number “5”, and the minutes character icon.

Further, the display data generating unit 28 generates a sixth time guide icon indicating “travel time to flower shop is 6 minutes” by combining the character string icon indicating the character string “flower shop”, the travel time character string icon, the character icon indicating “is”, the number icon indicating the number “6”, and the minutes character icon.

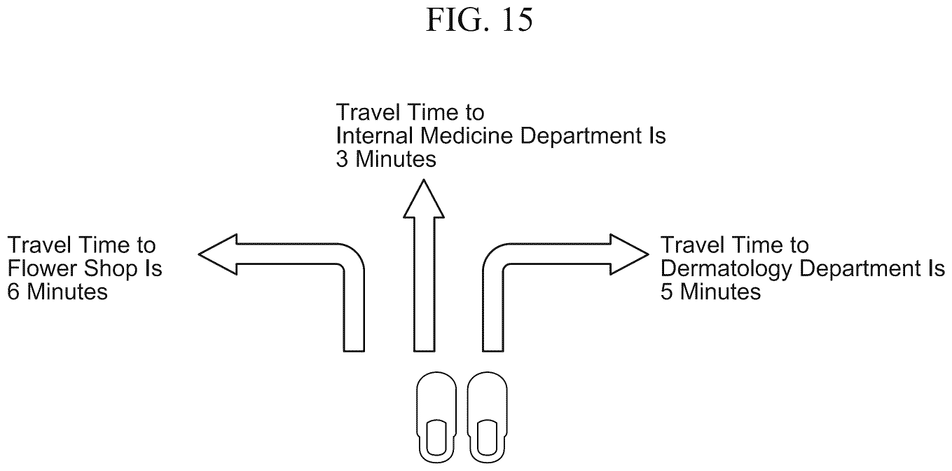

As illustrated in FIG. 15, the display data generating unit 28 generates display data to display a guide diagram including the straight arrow icon, the right turn arrow icon, the left turn arrow icon, the first time guide icon, the second time guide icon, and the sixth time guide icon.

The display data generating unit 28 outputs the display data to the projection device 12a of the guide apparatus 1.

FIG. 15 is an explanatory diagram illustrating an example of the guide diagram in the monitoring area.

The projection device 12a obtains the display data from the display data generating unit 28.

As illustrated in FIG. 15, the projection device 12a projects the guide diagram onto a floor surface or the like of the monitoring area in accordance with the display data.

When looking at the guide diagram projected on the floor surface or the like of the monitoring area, the facility user U1 can see that the travel time to the internal medicine department is 3 minutes and the facility user U1 can go straight to the internal medicine department. When looking at the guide diagram projected on the floor surface or the like of the monitoring area, the facility user U1 can see that the travel time to the dermatology department is 5 minutes, and the facility user U1 can go to the dermatology department by turning right. Further, when looking at the guide diagram projected on the floor surface or the like of the monitoring area, the facility user U1 can see that the travel time to the flower shop is 6 minutes and the facility user U1 can go to the flower shop by turning left.

In the fourth embodiment described above, the guide display control apparatus 2 is configured so that the travel time predicting unit 27 predicts the travel times, sets, as a sub destination, a point which is among a plurality of points in the facility and which is different from the destinations obtained by the destination obtaining unit 23, searches for a route from the monitoring area to the sub destination, and predicts a travel time of the facility user from the monitoring area to the sub destination on the basis of the search result of the route to the sub destination, and the display data generating unit 28 generates display data to display a guide diagram including arrows indicating routes to the respective destinations searched for by the travel time predicting unit 27, the travel time to each of the destinations predicted by the travel time predicting unit 27, an arrow indicating the route to the sub destination searched for by the travel time predicting unit 27, and the travel time to the sub destination predicted by the travel time predicting unit 27. Therefore, the guide display control apparatus 2 according to the fourth embodiment can show routes to respective destinations as does the guide display control apparatus 2 according to the first embodiment, and in addition, can show a route to a sub destination.

### Fifth Embodiment

In a fifth embodiment, a guide display control apparatus 2 including a congestion information obtaining unit 29 that obtains congestion information indicating a congestion status at each of the destinations obtained by the destination obtaining unit 23 will be described.

A configuration of a route guiding system according to the fifth embodiment is similar to the configurations of the route guiding systems according to the first and second embodiments, and the configuration diagram illustrating the route guiding system according to the fifth embodiment is FIG. 1 or FIG. 9.

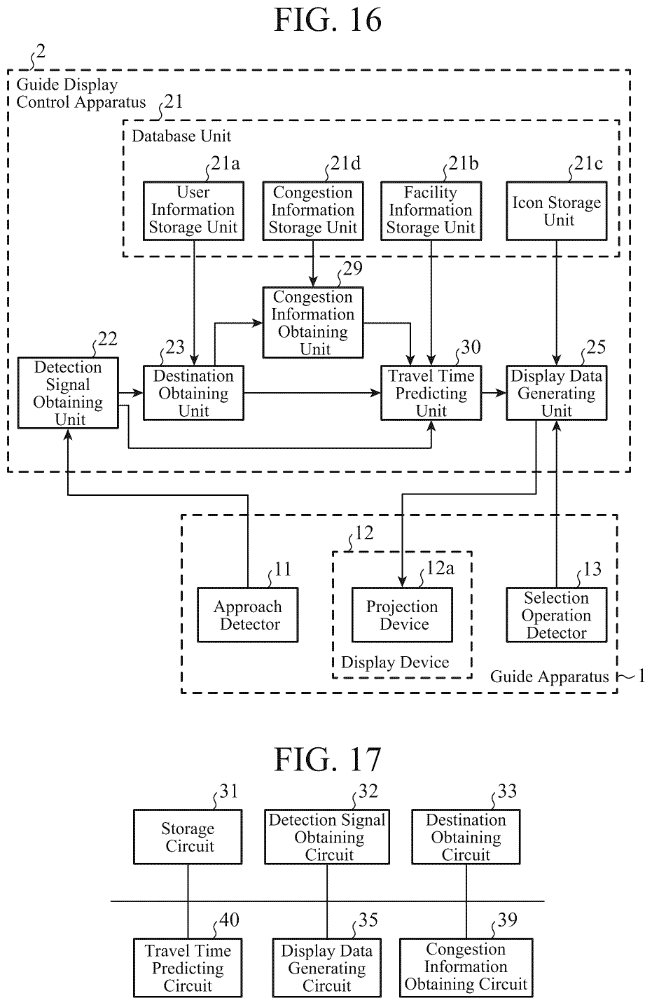

FIG. 16 is a configuration diagram illustrating the guide display control apparatus 2 according to the fifth embodiment.

FIG. 17 is a hardware configuration diagram illustrating hardware of the guide display control apparatus 2 according to the fifth embodiment.

In FIGS. 16 and 17, the same reference numerals as those in FIGS. 2 and 3 denote the same or corresponding parts, and thus description thereof is omitted.

The guide display control apparatus 2 illustrated in FIG. 16 includes the database unit 21, the detection signal obtaining unit 22, the destination obtaining unit 23, the congestion information obtaining unit 29, a travel time predicting unit 30, and the display data generating unit 25.

The database unit 21 includes the user information storage unit 21a, the facility information storage unit 21b, the icon storage unit 21c, and a congestion information storage unit 21d.

The congestion information storage unit 21d stores congestion information indicating congestion statuses at a plurality of points of the facility. When the facility is, for example, a shopping mall, the congestion information storage unit 21d stores congestion information indicating the congestion status at each of a plurality of stores included in the shopping mall. In a case where the facility is, for example, a hospital, the congestion information storage unit 21d stores congestion information indicating the congestion status at each of a plurality of visiting departments of the hospital.

The congestion information obtaining unit 29 is implemented by, for example, a congestion information obtaining circuit 39 illustrated in FIG. 17.

The congestion information obtaining unit 29 obtains congestion information indicating the congestion status at each of the destinations obtained by the destination obtaining unit 23 from the congestion information storage unit 21d.

The congestion information obtaining unit 29 outputs the congestion information indicating the congestion status at each of the destinations to the travel time predicting unit 30.

The travel time predicting unit 30 is implemented by, for example, a travel time predicting circuit 40 illustrated in FIG. 17.

The travel time predicting unit 30 obtains destination information from the destination obtaining unit 23, and obtains the congestion information indicating the congestion status at each of the destinations from the congestion information obtaining unit 29.

By referring to the map data stored in the facility information storage unit 21b, the travel time predicting unit 30 searches for routes from the monitoring area of the guide apparatus 1 indicated by the device number included in the detection signal to the respective destinations indicated by the destination information, as does the travel time predicting unit 24 illustrated in FIG. 2.

The travel time predicting unit 30 predicts the travel time from the monitoring area to each of the destinations on the basis of the search result of the route, as does the travel time predicting unit 24 illustrated in FIG. 2.

Unlike the travel time predicting unit 24 illustrated in FIG. 2, the travel time predicting unit 30 predicts a waiting time for the facility user at each of the destinations on the basis of the congestion information obtained by the congestion information obtaining unit 29.

The travel time predicting unit 30 includes the waiting time for the facility user at each of the destinations in the travel time of the facility user from the monitoring area to the destination.

The travel time predicting unit 30 outputs the search result of the routes and the travel time to each of the destinations including the waiting time at the destination to the display data generating unit 25.

In the guide display control apparatus 2 illustrated in FIG. 16, the congestion information storage unit 21d, the congestion information obtaining unit 29, and the travel time predicting unit 30 are applied to the guide display control apparatus 2 illustrated in FIG. 2. However, this is merely an example, and the congestion information storage unit 21d, the congestion information obtaining unit 29, and the travel time predicting unit 30 may be applied to the guide display control apparatus 2 illustrated in FIG. 10 or the guide display control apparatus 2 illustrated in FIG. 13.

In FIG. 16, it is assumed that each of the database unit 21, the detection signal obtaining unit 22, the destination obtaining unit 23, the congestion information obtaining unit 29, the travel time predicting unit 30, and the display data generating unit 25, which are components of the guide display control apparatus 2, is implemented by dedicated hardware as illustrated in FIG. 17. That is, it is assumed that the guide display control apparatus 2 is implemented by the storage circuit 31, the detection signal obtaining circuit 32, the destination obtaining circuit 33, the congestion information obtaining circuit 39, the travel time predicting circuit 40, and the display data generating circuit 35.

Each of the detection signal obtaining circuit 32, the destination obtaining circuit 33, the congestion information obtaining circuit 39, the travel time predicting circuit 40, and the display data generating circuit 35 corresponds to, for example, a single circuit, a composite circuit, a programmed processor, a parallel-programmed processor, an ASIC, an FPGA, or a combination thereof.

The components of the guide display control apparatus 2 are not limited to those implemented by dedicated hardware, and the guide display control apparatus 2 may be implemented by software, firmware, or a combination of software and firmware.

When the guide display control apparatus 2 is implemented by software, firmware, or the like, the database unit 21 is formed on the memory 41 of the computer. A program for causing the computer to execute each processing procedure performed in the detection signal obtaining unit 22, the destination obtaining unit 23, the congestion information obtaining unit 29, the travel time predicting unit 30, and the display data generating unit 25 is stored in the memory 41 illustrated in FIG. 4. Then, the processor 42 illustrated in FIG. 4 executes the program stored in the memory 41.

Further, FIG. 17 illustrates an example in which each of the components of the guide display control apparatus 2 is implemented by dedicated hardware, and FIG. 4 illustrates an example in which the guide display control apparatus 2 is implemented by software, firmware, or the like. However, this is merely an example, and some components in the guide display control apparatus 2 may be implemented by dedicated hardware, and the remaining components may be implemented by software, firmware, or the like.

Next, the operation of the guide display control apparatus 2 illustrated in FIG. 16 will be described. It is similar to that of the guide display control apparatus 2 illustrated in FIG. 2 except for the congestion information obtaining unit 29 and the travel time predicting unit 30, and thus only the operation of the congestion information obtaining unit 29 and the travel time predicting unit 30 will be described here.

When the facility is, for example, a shopping mall, a human sensor, a monitoring camera, or the like is installed in each store as a monitoring sensor that monitors a congestion status at the store included in the shopping mall. The monitoring sensor outputs, for example, congestion information indicating the number of people waiting at a cash register of a store or at an entrance of the store to the congestion information storage unit 21d.

When the facility is, for example, a hospital, a human sensor, a monitoring camera, or the like is installed in each department as a monitoring sensor that monitors the congestion status at the department. For example, the monitoring sensor outputs congestion information indicating the number of people waiting in a waiting room of a department to the congestion information storage unit 21d.

The congestion information storage unit 21d obtains congestion information output from a monitoring sensor installed at each point of the facility and stores the congestion information.

The travel time predicting unit 30 obtains destination information from the destination obtaining unit 23, and obtains the congestion information indicating the congestion status at each of the destinations from the congestion information obtaining unit 29.

By referring to the map data stored in the facility information storage unit 21b, the travel time predicting unit 30 searches for routes from the monitoring area of the guide apparatus 1 indicated by the device number included in the detection signal to the respective destinations indicated by the destination information, as does the travel time predicting unit 24 illustrated in FIG. 2.

The travel time predicting unit 30 predicts the travel time from the monitoring area to each of the destinations on the basis of the search result of the route, as does the travel time predicting unit 24 illustrated in FIG. 2.

Unlike the travel time predicting unit 24 illustrated in FIG. 2, the travel time predicting unit 30 predicts a waiting time for the facility user at each of the destinations on the basis of the congestion information.

The travel time predicting unit 30 includes the waiting time for the facility user at each of the destinations in the travel time of the facility user from the monitoring area to the destination.

Hereinafter, prediction processing of a travel time T′ by the travel time predicting unit 30 will be specifically described.

First, as expressed in the following Expression (3), the travel time predicting unit 30 predicts the travel time T to each of the destinations by dividing the distance L of the route from the monitoring area to the destination by the walking speed V1 of the facility user U1 to.

T=L/V1 (3)

Next, as illustrated in the following Expression (4), the travel time predicting unit 30 sets a larger coefficient K as the degree of congestion indicated by the congestion information is larger, and multiplies the initial time T₀ by a coefficient K to calculate the waiting time T_{W}. K is a value equal to or more than 0, and K=0 when the number of people waiting in a register or the like of the store is zero or the number of people waiting in the waiting room of the department is zero. T₀ is an integer equal to or more than 1.

T_{W}=K×T₀ (4)

In Expression (4), K is set depending on the number of people currently standing in line at the destination or the number of people currently waiting at the destination. However, this is merely an example. In a case where a user different from the facility user (hereinafter referred to as “other user”) has not arrived at the destination at the present time, but is predicted to arrive at the destination earlier than the facility user, K may be set depending on the sum of the number of people currently standing in line at the destination or the number of people currently waiting at the destination and the number of other users. The number of other users may be, for example, the number of people who have reserved to use the destination earlier than the time when the facility user is predicted to arrive at the destination, the number of people who pass through the monitoring area earlier than the facility user and head for the destination, or the like.

The travel time predicting unit 30 can grasp the number of people who pass through the monitoring area earlier than the facility user and head for the destination on the basis of the detection result of the route selection operation by the other user generated by the selection operation detector 13.

Next, the travel time predicting unit 30 predicts the travel time T′ including the waiting time T_{W} as illustrated in the following Expression (5) by adding the waiting time T_{W} to the predicted travel time T.

T′=T+T_{W} (5)

The travel time predicting unit 30 outputs a search result of the routes to the respective destinations and the travel time T′ to each of the destinations to the display data generating unit 25.

In the fifth embodiment described above, the guide display control apparatus 2 is configured to include the congestion information obtaining unit 29 that obtains the congestion information indicating the congestion status at each of the destinations obtained by the destination obtaining unit 23. Further, in the guide display control apparatus 2 according to the fifth embodiment, the travel time predicting unit 30 predicts the waiting time for the facility user at each of the destinations on the basis of the congestion information obtained by the congestion information obtaining unit 29, and includes the waiting time for the facility user at each of the destinations in the travel time of the facility user from the monitoring area to the destination. Therefore, the guide display control apparatus 2 according to the fifth embodiment can show routes to respective destinations as does the guide display control apparatus 2 according to the first embodiment, and in addition, can show a travel time including a waiting time at each of the destinations.

In the route guiding systems according to the first to fifth embodiments, the display device 12 includes the projection device 12a, and the projection device 12a projects the guide diagram on the floor surface or the like of the monitoring area in accordance with the display data. However, this is merely an example. The display device 12 may include, for example, an indicator having a display instead of the projection device 12a, and the indicator may display the guide diagram on the display in accordance with the display data.

In the guide display control apparatuses 2 according to the first to fifth embodiments, the display data generating unit 25 or the display data generating unit 28 generates display data to display a guide diagram. However, this is merely an example. The display data generating unit 25 or the display data generating unit 28 may generate voice data for outputting each of a route guide and a travel time by voice, and output the voice data to a voice output device, which is not illustrated, of the guide apparatus 1.

Note that, in the present disclosure, free combinations of the embodiments, modifications of any components of the embodiments, or omissions of any components in the embodiments are possible.

### INDUSTRIAL APPLICABILITY

The present disclosure is suitable for a guide display control apparatus, a guide display control method, and a route guiding system.

### REFERENCE SIGNS LIST

1: guide apparatus, 2: guide display control apparatus, 11: approach detector, 12: display device, 12a: projection device, 13: selection operation detector, 14: man-machine interface unit, 21: database unit, 21a: user information storage unit, 21b: facility information storage unit, 21c: icon storage unit, 21d: congestion information storage unit, 22: detection signal obtaining unit, 23: destination obtaining unit, 24: travel time predicting unit, 25: display data generating unit, 26: associating unit, 27: travel time predicting unit, 28: display data generating unit, 29: congestion information obtaining unit, 30: travel time predicting unit, 31: storage circuit, 32: detection signal obtaining circuit, 33: destination obtaining circuit, 34: travel time predicting circuit, 35: display data generating circuit, 36: associating circuit, 37: travel time predicting circuit, 38: display data generating circuit, 39: congestion information obtaining circuit, 40: travel time predicting circuit, 41: memory, 42: processor

1. A guide display control apparatus comprising:
detection signal obtaining circuitry to obtain a detection signal including identification information of a facility user who has entered a monitoring area from an approach detector that detects entry of the facility user into the monitoring area;
destination obtaining circuitry to obtain a plurality of destinations associated with the identification information included in the detection signal obtained by the detection signal obtaining circuitry;
travel time predicting circuitry to search for routes from the monitoring area to the respective destinations obtained by the destination obtaining circuitry, and predict a travel time of the facility user from the monitoring area to each of the destinations on a basis of a search result of the routes; and
display data generating circuitry to generate display data to display a guide diagram including arrows each indicating a corresponding one of the routes to the respective destinations searched for by the travel time predicting circuitry and the travel time to each of the destinations predicted by the travel time predicting circuitry, wherein
the travel time predicting circuitry
calculates, when each of the destinations obtained by the destination obtaining circuitry is a destination with a limited use time, a remaining time until a time limit for use of a corresponding one of the destinations instead of predicting the travel time, and
the display data generating circuitry
generates display data to display a guide diagram including the arrows each indicating the corresponding one of the routes to the respective destinations searched for by the travel time predicting circuitry and the remaining time for each of the destinations calculated by the travel time predicting circuitry.

2. The guide display control apparatus according to claim 1, further comprising associating circuitry to obtain the identification information and a destination of the facility user, and associate the obtained identification information with the obtained destination.

3. The guide display control apparatus according to claim 1, wherein
the travel time predicting circuitry
predicts the travel time, and
sets, as a sub destination, a point which is among a plurality of points in a facility and which is different from the destinations obtained by the destination obtaining circuitry, searches for a route from the monitoring area to the sub destination, and predicts a travel time of the facility user from the monitoring area to the sub destination on a basis of a search result of the route to the sub destination, and
the display data generating circuitry
generates display data to display a guide diagram including the arrows each indicating the corresponding one of the routes to the respective destinations searched for by the travel time predicting circuitry, the travel time to each of the destinations predicted by the travel time predicting circuitry, an arrow indicating the route to the sub destination searched for by the travel time predicting circuitry, and the travel time to the sub destination predicted by the travel time predicting circuitry.

4. The guide display control apparatus according to claim 1, further comprising:
congestion information obtaining circuitry to obtain congestion information indicating a congestion status at each of the destinations obtained by the destination obtaining circuitry, wherein
the travel time predicting circuitry
predicts a waiting time for the facility user at each of the destinations on a basis of the congestion information obtained by the congestion information obtaining circuitry, and includes the waiting time for the facility user at each of the destinations in the travel time of the facility user from the monitoring area to a corresponding one of the destinations.

5. A guide display control method comprising:
obtaining a detection signal including identification information of a facility user who has entered a monitoring area from an approach detector that detects entry of the facility user into the monitoring area;
obtaining a plurality of destinations associated with the identification information included in the detection signal obtained;
searching for routes from the monitoring area to the respective destinations obtained, and predicting a travel time of the facility user from the monitoring area to each of the destinations on a basis of a search result of the routes;
generating display data to display a guide diagram including arrows each indicating a corresponding one of the routes to the respective destinations and the predicted travel time to each of the destinations;
calculating, when each of the destinations obtained is a destination with a limited use time, a remaining time until a time limit for use of a corresponding one of the destinations instead of predicting the travel time; and
generating display data to display a guide diagram including the arrows each indicating the corresponding one of the routes to the respective destinations and the calculated remaining time for each of the destinations.

6. A route guiding system comprising:
an approach detector to perform entry detection processing of detecting entry of a facility user into a monitoring area, and output a detection signal including identification information of the facility user who has entered the monitoring area;
the guide display control apparatus according to claim 1; and
a display device to display the guide diagram in accordance with the display data generated by the display data generating circuitry of the guide display control apparatus.

7. The route guiding system according to claim 6, further comprising:
a selection operation detector to detect a selection operation by the facility user to select a route to one of the plurality of destinations from among the routes to the respective destinations after the guide diagram is displayed by the display device, wherein
the display data generating circuitry regenerates display data to display a guide diagram including an arrow indicating the route selected by the selection operation detected by the selection operation detector and a travel time to the one of the destinations which is related to the selected route.
